(19) United States
(12) Patent Application Publication
(10) Pub. No.: US 2016/0325452 A1
(43) Pub. Date: Nov. 10, 2016

(54) MOBILE RIGID INSULATION BOARD SCORER

(71) Applicant: Joshua Roberts, Hastings, MI (US)

(72) Inventor: Joshua Roberts, Hastings, MI (US)

(21) Appl. No.: 14/703,114

(22) Filed: May 4, 2015

(51) Int. Cl. B26D 3/08; B26D 1/16

(52) U.S. Cl. CPC B26D 3/085; B26D 1/165

(57) ABSTRACT

A board scoring device for insulation board that is mobile enough to be carried on a roof and can easily score the top and bottom surfaces to be separated into multiple boards.

### FIELD OF THE INVENTION

This invention relates to an apparatus that is used to place scoring lines in boards, particularly insulation boards for roofing, so the larger board may be separated along the scoring lines. The invention can easily be carried or transferred to roofs for use.

### BACKGROUND OF THE INVENTION

There exists a need for a mobile rigid insulation board scorer that can be carried on a roof and set up by deploying or unfolding a set of legs.

There exists a need for a board scorer whereby the user can place a rigid insulation board (“board”) adjacent a guide, then the board can be displaced through the scorer.

There is a need for a board scorer that may have a blade (rolling or static) that can cut into the board on both the top and bottom side as it is moving through the board scorer.

There is a need for a board scorer blade having a nylon spacer that may be disposed immediately adjacent to the blade to disperse pressure from adjacent the blade to reduce or eliminate further deformation of the board.

There is a need for a board scorer that has multiple blades spaced apart to score the board in separate sections.

Then the board can be moved to its desired location and then impacted or hit near the scoring line to break the board apart.

Multiple embodiments of the system are disclosed herein. It will be understood that other objects and purposes of the invention, and variations thereof, will be apparent upon reading the following specification and inspecting the accompanying drawings.

### SUMMARY OF THE INVENTION

One aspect of the present invention is a board scorer, comprising: an upper blade; a lower blade; said upper blade slidably disposed on an upper arm; said lower blade slidably disposed on a lower arm; whereby an upper surface of a board is scored and a lower surface of said board is scored when displaced through the board scorer and between said upper blade and said lower blade.

Another aspect of the present invention is a board scorer, comprising: Multiple upper blades; multiple lower blades; said upper blades slidably disposed on an upper arm; said lower blades slidably disposed on a lower arm; whereby an upper surface of a board is scored and a lower surface of said board is scored when displaced through the board scorer and between said upper blade and said lower blade; a measuring device disposed near said lower arm; two bodies secured to a base separated by a distance to define a channel; a first body disposed in front of a second body; a support extending upwardly having a height adjustment means whereby said upper arm can be positioned at different distances from said lower arm; a spacer disposed leftwardly and rightwardly and immediately adjacent to said upper blade and to said lower blade; a guide rail is disposed securely on the left side of the board scorer and another guide rail is securely disposed on the right side of the board scorer to guide a board when displaced through said upper blade and said lower blade.

Another aspect of the present invention is a board scorer, consisting of: three upper blades; three lower blades; said upper blades slidably disposed on an upper arm; said lower blades slidably disposed on a lower arm; whereby an upper surface of a board is scored and a lower surface of said board is scored when displaced through the board scorer and between said upper blade and said lower blade; a measuring device disposed near said lower arm; two bodies secured to a base separated by a distance to define a channel; a first body disposed in front of a second body; a support extending upwardly having a height adjustment means whereby said upper arm can be positioned at different distances from said lower arm; a spacer disposed leftwardly and rightwardly and immediately adjacent to said upper blade and to said lower blade; a guide rail is disposed securely on the left side of the board scorer and another guide rail is securely disposed on the right side of the board scorer to guide a board when displaced through said upper blade and said lower blade.

These and other features, aspects and advantages of the present invention will become better understood with reference to the following drawings, description and claims.

### BRIEF DESCRIPTION OF THE DRAWINGS

FIG. 1 is a pictorial view of one embodiment of the front of the present invention;

FIG. 2 is another pictorial view of one embodiment of the present invention;

FIG. 3 is pictorial view of one embodiment of the rear of the present invention in a track and interchange;

FIG. 4 is a pictorial view of an embodiment of a blade of the present invention;

FIG. 5 is a pictorial view of an embodiment of the side of the present invention;

FIG. 6 is a pictorial view of another embodiment of the side of the present invention;

FIG. 7 is a pictorial view of another embodiment for one person use; and

FIG. 8 is a pictorial view of a board after it is scored.

### DETAILED DESCRIPTION OF THE INVENTION

### Reference Numerals List

10 mobile rigid insulation board scorer

20 support

30 body

40 upper arm

50 lower blade

60 upper blade

70 adjustable guide rail

80 measuring device

90 column

100 slot

110 height adjustment means

120 channel

130 lower blade adjustment means

140 upper blade adjustment means

150 spacer

160 lower arm

170 bracket

180 base

190 board

200 conveyor

210 scoring line

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

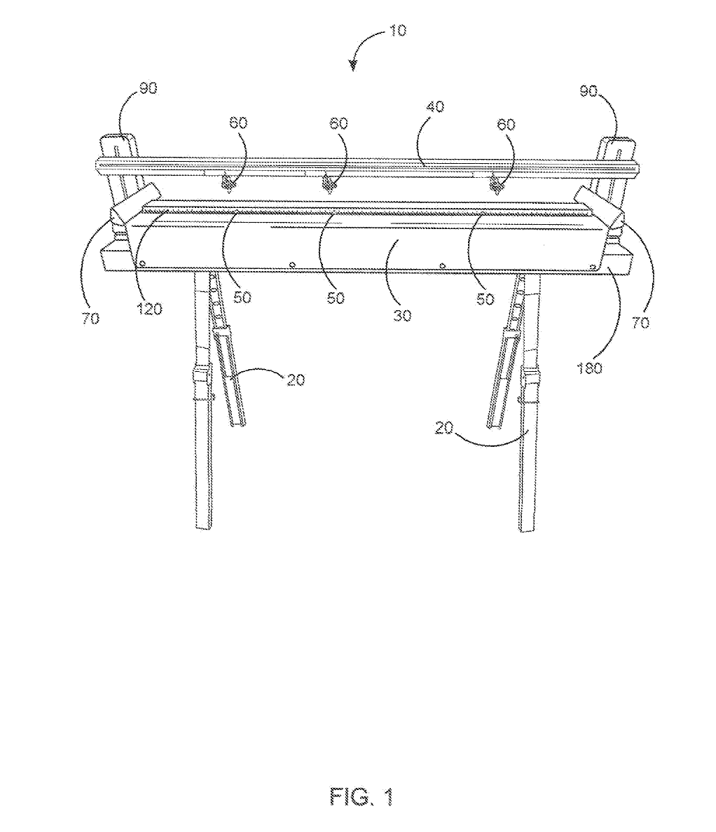

FIG. 1 illustrates one embodiment of the present invention, referred to as a mobile rigid insulation board scorer 10. The purpose of the board scorer 10 is to make a small cut, or score an upper and lower surface of insulation board that is usually used for roofing.

An upper surface of the board 190, and a lower surface of the board 190 is scored. The score is a linear surface cut, and the score on the upper surface is usually located opposite of the score on the lower surface. The score usually runs the length of the board. See FIG. 8.

In most cases the board is scored at desired widths so as to separate the board 190 in to desired widths.

FIG. 1 illustrates the scorer 10 having a support 20 to support the body 30 and other components at a height convenient for a person to place an insulation board between the body 30 and arm 40 that is disposed upwardly from the body 30.

In one embodiment the support 20 is foldably connected to a base 180, as best seen in FIG. 6.

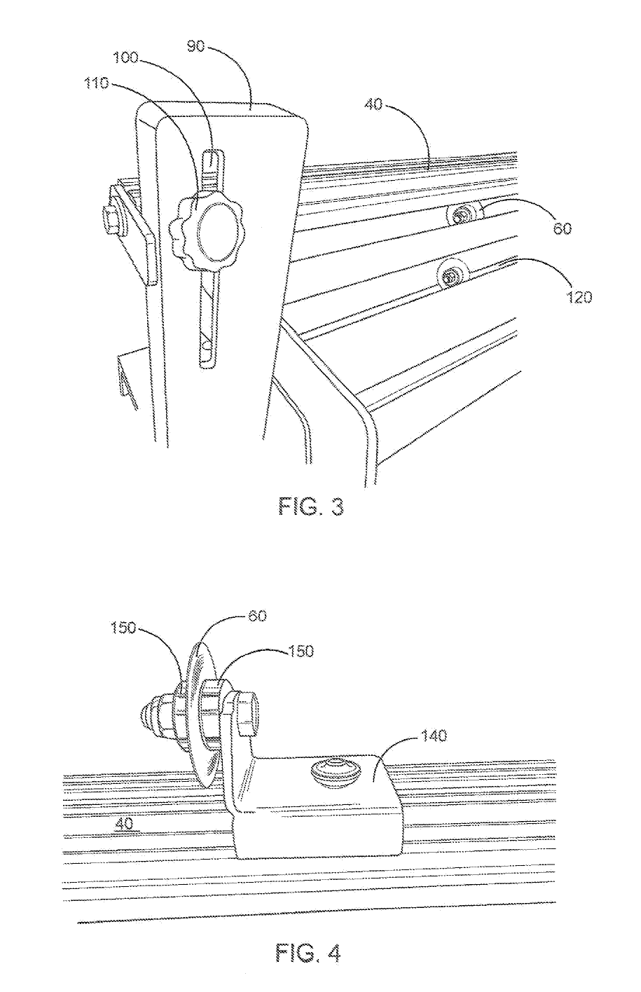

FIG. 1 also illustrates a lower blade 50 and an upper blade 60. The upper blade 60 may be slidably disposed on an arm 40. The arm 40 may be slidably disposed on two opposed columns 90 so it may be displaced upwardly and downwardly and secured into the desired position, as best seen in FIG. 3.

A measuring device 80 may be disposed on one of the body's 30 so that the user can place the lower blades 60 or upper blades 50 at desired locations and distances.

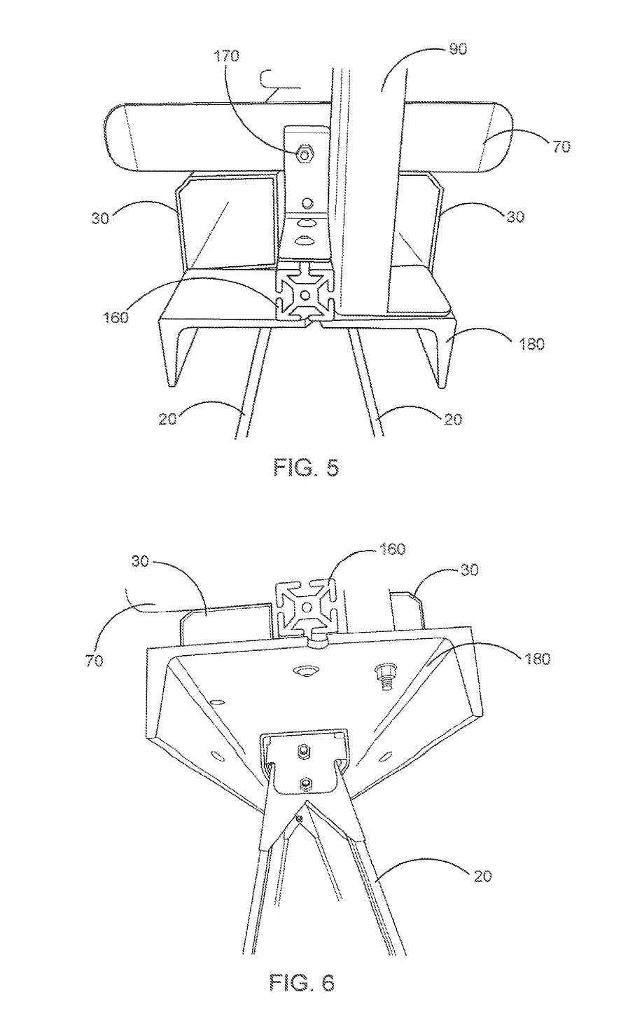

As illustrated in FIG. 1 a guide rail 70 may be disposed leftwardly and rightwardly on the body 30. As illustrated in FIG. 5, there may be two (2) bodies, one may be disposed in front of the other body 30. The guide rail 70 may assist the user in positioning, guiding, and moving the insulation board rearwardly through the board scorer 10. The guide rail 70 is adjustable for boards of different widths. For example the guide rail 70 may adjust from a width of 0 inches to 49 inches. The adjustable guide rail 70 can be moved by relocating the bracket 170 along the lower arm 160 as the adjustable guide rail 70 is fixed to the bracket 170.

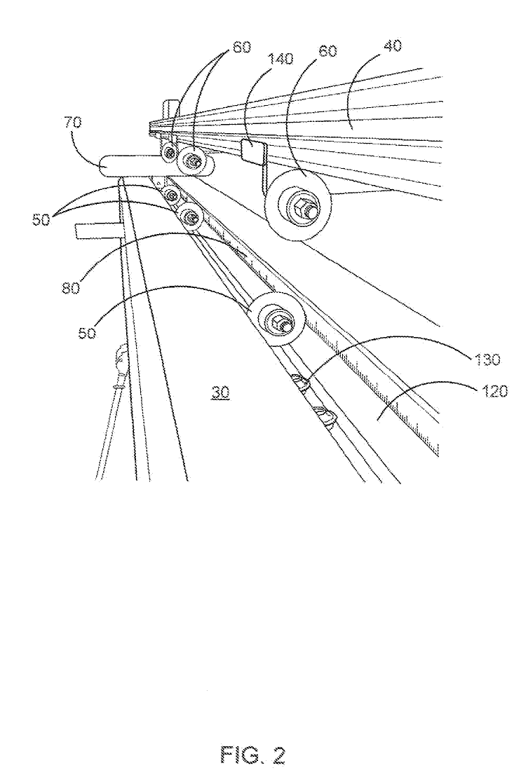

As illustrated in FIG. 2 the two (2) bodies 30 may be separated by a distance to define a channel 120. The lower arm 130 may be disposed in the channel 120 on a base 180. The lower blade 50 may be slidably disposed on the lower arm 40. The upper blade 60 may be slidably disposed on the upper arm 40. The lower blade 50 may be slid along the lower arm 160 and positioned at a desired location, and then locked in place via a lower blade adjustment means 130. In one embodiment the lower blade adjustment means 130 may be a threaded fastener that secures the lower blade adjustment means 130 to the lower arm 160. Or it may be a pin that enters a hole.

Similarly the upper blade adjustment means 140 may be slid and locked in place to the upper arm 40.

FIG. 3 illustrates an embodiment of the rear of the board scorer 10. A height adjustment means 110 is illustrated. In one embodiment the height adjustment means 110 may be a threaded handle that can screw toward the column 90 until it is secured against the column 90 to secure the upper arm 40 in place.

FIG. 3 also illustrates the upper blade 60 and the channel 120.

FIG. 4 illustrates an embodiment of the upper blade adjustment means 140 having an Allen wrench fastener that can be rotated and contact the upper arm 40 to secure the upper blade adjustments means 140 to the upper arm 40. Likewise the upper blade 50 being secured to the upper blade adjustment means 140 is secured in position. FIG. 4 also illustrates a spacer 150 disposed on both sides of the upper blade 60.

FIG. 5 illustrates a side view of an embodiment of the board scorer 10. Each of the two (2) bodies 30 may be secured to the base 180. The lower arm 160 may be secured to the base 180. The bottom of the column 90 may also be connected to the base 180. An L-shaped bracket 170 may be secured to the top of the lower arm 160 to extend inwardly and upwardly. The guide rail 70 may be connected to the bracket 170.

FIG. 6 illustrates an embodiment of the present invention board scorer from the side and underneath. The supports 20 may be foldable and stowed entirely under the base 180 for transportation and moving of the board scorer 10. Both bodies 30 are illustrated, one body 30 in front of the other body 30 to define a channel 120, with the lower arm 16 disposed in the channel 120 and the lower arm 160 secured to the base 180. The guide rail 70 is also illustrated.

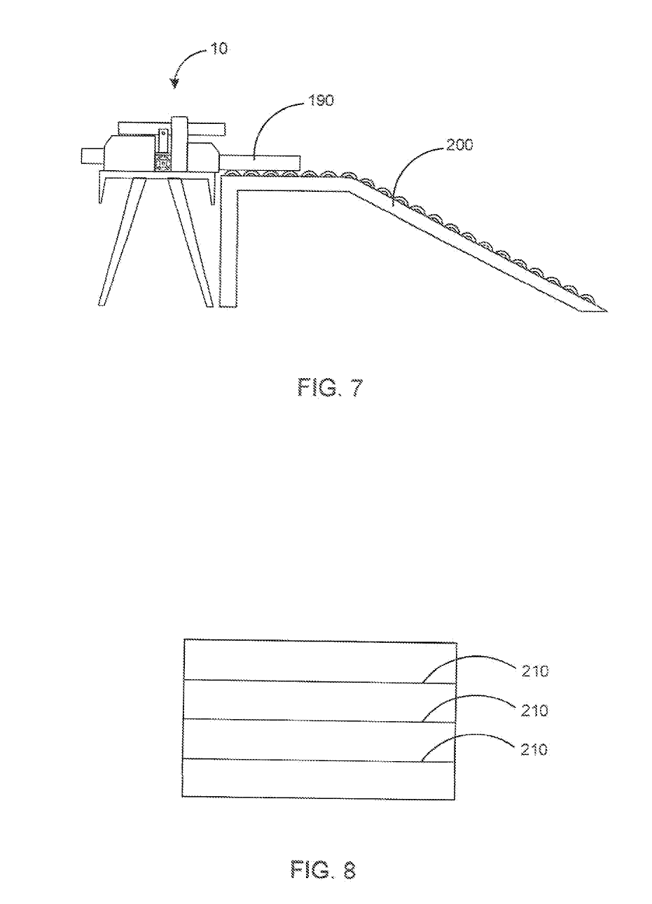

FIG. 7 illustrates an embodiment whereby one person can place the board in the board scorer 10, and the board 190 then slides on a conveyor 200 to be stacked one on top of the other. This allows only one person to use the board scorer 10, rather than one person feeding the board 190 through the board scorer 10, and a second person to receive the scored board 190.

FIG. 8 illustrates one surface of the board 190 with three (3) scoring lines so the board 190 can easily be hit or impacted along the scoring lines 210 so the board 190 can be separated into four (4) separate boards.

I claim:

1. A board scorer (10), comprising:
an upper blade (60);
a lower blade (50);
said upper blade (60) slidably disposed on an upper arm (40);
said lower blade (50) slidably disposed on a lower arm (160);
whereby an upper surface of a board is scored and a lower surface of said board is scored when displaced through the board scorer (10) and between said upper blade (60) and said lower blade (50).

2. The apparatus of claim 1, further comprising:
a measuring device (80) disposed near said lower arm (160).

3. The apparatus of Claim, 1, further comprising:
two bodies (30) secured to a base (180) separated by a distance to define a channel (120).

4. The apparatus of claim 3, further comprising:
a support (20) extending upwardly having a height adjustment means (110) whereby said upper arm (40) can be positioned at different distances from said lower arm (160).

5. The apparatus of claim 1, wherein said upper blade (60) is circular and can rotate about an axis.

6. The apparatus of claim 1, wherein said lower blade (50) is circular and can rotate about an axis.

7. The apparatus of claim 1 wherein a spacer (150) is disposed leftwardly and rightwardly and immediately adjacent to said upper blade (60) and to said lower blade (50).

8. The apparatus of claim 1, wherein a guide rail (70) is disposed securely on the left side of the board scorer (10) and another guide rail (70) is securely disposed on the right side of the board scorer (10) to guide a board when displaced through said upper blade (60) and said lower blade (50).

9. The apparatus of claim 8, wherein said guide rail (70) is adjustable for boards with different widths.

10. The apparatus of claim 1, further comprising: three upper blades (60) and three lower blades (50).

11. The apparatus of claim 1, further comprising: multiple upper blades (60) and multiple lower blades (50)

12. The apparatus of claim 1, further comprising a conveyor (200) that is operably connected to the board scorer (10) whereby one person can place the board in the board scorer (10), and the board then slides on a conveyor (200) to a desired location.

13. A board scorer (10), comprising:
multiple upper blades (60);
multiple lower blades (50);
said upper blades (60) slidably disposed on an upper arm (40);
said lower blades (50) slidably disposed on a lower arm (160);
whereby an upper surface of a board is scored and a lower surface of said board is scored when displaced through the board scorer (10) and between said upper blade (60) and said lower blade (50);
a measuring device (80) disposed near said lower arm (160);
two bodies (30) secured to a base (180) separated by a distance to define a channel (120); a first body (30) disposed in front of a second body (30);
a support (20) extending upwardly having a height adjustment means (110) whereby said upper arm (40) can be positioned at different distances from said lower arm (160);
a spacer (150) disposed leftwardly and rightwardly and immediately adjacent to said upper blade (60) and to said lower blade (50);
an adjustable guide rail (70) is disposed securely on the left side of the board scorer (10) and another guide rail (70) is securely disposed on the right side of the board scorer (10) to guide a board when displaced through said upper blade (60) and said lower blade (50).

14. The apparatus of claim 13, wherein said upper blade (60) is circular and can rotate about an axis.

15. The apparatus of claim 13, wherein said lower blade (50) is circular and can rotate about an axis.

16. The apparatus of claim 13, further comprising:
a conveyor (200) that is operably connected to the board scorer (10) whereby one person can place the board in the board scorer (10), and the board then slides on a conveyor (200) to a desired location.

17. A board scorer (10), consisting of:
three upper blades (60);
three lower blades (50);
said upper blades (60) slidably disposed on an upper arm (40);
said lower blades (50) slidably disposed on a lower arm (160);
whereby an upper surface of a board is scored and a lower surface of said board is scored when displaced through the board scorer (10) and between said upper blade (60) and said lower blade (50);
a measuring device (80) disposed near said lower arm (160);
two bodies (30) secured to a base (180) separated by a distance to define a channel (120); a first body (30) disposed in front of a second body (30);
a support (20) extending upwardly having a height adjustment means (110) whereby said upper arm (40) can be positioned at different distances from said lower arm (160);
a spacer (150) disposed leftwardly and rightwardly and immediately adjacent to said upper blade (60) and to said lower blade (50);
a adjustable guide rail (70) is disposed securely on the left side of the board scorer (10) and another adjustable guide rail (70) is securely disposed on the right side of the board scorer (10) to guide a board when displaced through said upper blade (60) and said lower blade (50).

18. The apparatus of claim 17, wherein said upper blade (60) is circular and can rotate about an axis.

19. The apparatus of claim 17, wherein said lower blade (50) is circular and can rotate about an axis.

20. The apparatus of claim 17, further comprising:
a conveyor (200) that is operably connected to the board scorer (10) whereby one person can place the board in the board scorer (10), and the board then slides on a conveyor (200) to a desired location.
